(19) United States
(12) Patent Application Publication
(10) Pub. No.: US 2021/0279508 A1
(43) Pub. Date: Sep. 9, 2021

(54) IMAGE PROCESSING METHOD, APPARATUS AND STORAGE MEDIUM

(71) Applicant: SHENZHEN SENSETIME TECHNOLOGY CO., LTD., Shenzhen (CN)

(72) Inventors: Senhui GUO, Shenzhen (CN); Jing XU, Shenzhen (CN); Dapeng CHEN, Shenzhen (CN); Rui ZHAO, Shenzhen (CN)

(21) Appl. No.: 17/328,432

(22) Filed: May 24, 2021

Related U.S. Application Data
(63) Continuation of application No. PCT/CN2020/081364, filed on Mar. 26, 2020.

(30) Foreign Application Priority Data
Feb. 18, 2020 (CN) 202010098842.0

(51) Int. Cl. G06K 9/62

(52) U.S. Cl. CPC G06K 9/6226; G06K 9/629; G06K 9/6276; G06K 9/6228

(57) ABSTRACT

The present disclosure relates to an image processing method and apparatus, an electronic device and a storage medium. The method includes: according to first features of a plurality of first images to be processed, determining respectively a density of each of the first feature; determining density chain information corresponding to a target feature according to the density of the target feature, wherein the target feature is any one of the first features, the density chain information corresponding to the target feature includes N features, an i^{th} feature of the N features is one of first nearest neighbor features of an (i−1)^{th} feature, and the density of the i^{th} feature is greater than the density of the (i−1)^{th} feature; adjusting respectively each of the first features according to the density chain information corresponding to each of the first features to obtain second features of the plurality of first images; and clustering the second features of the plurality of first images to obtain a processing result of the plurality of first images. The embodiments of the present disclosure can improve the effect of clustering images.

The present application is a continuation of and claims priority under 35 U.S.C. § 111(a) to PCT Application. No. PCT/CN2020/081364, filed on Mar. 26, 2020, which claims priority of Chinese Patent Application entitled “IMAGE PROCESSING METHOD AND APPARATUS, ELECTRONIC DEVICE AND STORAGE MEDIUM” filed with the CNIPA on Feb. 18, 2020, with the Application No. 202010098842.0, the entire contents of which are incorporated herein by reference.

### TECHNICAL FIELD

The present disclosure relates to the technical field of computers, and particularly to an image processing method and apparatus, an electronic device and a storage medium.

### BACKGROUND

Clustering can cluster a plurality of objects (such as faces of human) of a same class together. For example, images of a same person in an image library can be clustered together so as to distinguish the images of different persons. In a related art, features of an object in the image can be extracted, and the features are clustered.

### SUMMARY

The present disclosure provides an image processing technical solution.

According to one aspect of the present disclosure, there is provided an image processing method, including: according to first features of a plurality of first images to be processed, determining respectively a density of each of the first features, wherein the density of a first feature represents a number of first features whose distance from said first feature is less than or equal to a first distance threshold; determining density chain information corresponding to a target feature according to the density of the target feature, wherein the target feature is any one of the first features; the density chain information corresponding to the target feature includes N features; an i^{th} feature of the N features is one of first nearest neighbor features of an (i−1)^{th} feature of the N features, and the density of the i^{th} feature is greater than the density of the (i−1)^{th} feature; N and i are positive integers, and 1<i≤N; and the first nearest neighbor features include at least one first feature whose distance from the (i−1)^{th} feature is less than or equal to a second distance threshold, and the target feature is the first one of the N features; adjusting respectively each of the first features according to the density chain information corresponding to each of the first features to obtain second features of the plurality of first images; and clustering the second features of the plurality of first images to obtain a processing result of the plurality of first images.

In a possible implementation, the density chain information corresponding to the target feature further includes second nearest neighbor features of the N features, and the second nearest neighbor features of the (i−1)^{th} feature of the N features include at least one first feature whose distance from the (i−1)^{th} is less than or equal to a third distance threshold, and adjusting respectively each of the first features according to the density chain information corresponding to each of the first features to obtain second features of the plurality of first images comprises: for the target feature, fusing respectively the N features and the second nearest neighbor features of the N features to obtain N fused features of the target feature; determining an associating feature among the N fused features according to the N fused features of the target feature; and determining the second features of the first images corresponding to the target feature according to the N fused features of the target feature and the associating feature.

In a possible implementation, determining the second features of the first images corresponding to the target feature according to the N fused features of the target feature and the associating feature comprises: splicing the associating feature respectively with the N fused features to obtain N spliced features; normalizing the N spliced features to obtain N weight values for the N fused features; and fusing the N fused features according to the N weight values to obtain the second features of the first images corresponding to the target feature.

In a possible implementation, prior to determining respectively a density of each of the first features according to first features of a plurality of first images to be processed, the method further includes: establishing a feature map network according to third features of the plurality of first images, wherein the feature map network includes a plurality of nodes and connecting lines among the nodes; each of the nodes includes one of the third features, a value of the connecting line represents a distance between the node and a nearest neighbor node of the node; and the nearest neighbor nodes of the node include K nodes of a minimal distance from the node, where K is a positive integer; and performing a map convolution on the feature map network to obtain the first features of the plurality of first images.

In a possible implementation, wherein the i^{th} feature of the N features is a feature with a maximum density among the first nearest neighbor features of the (i−1)^{th} feature of the N features.

In a possible implementation, prior to establishing a feature map network according to third features of the plurality of first images, the method further includes: performing feature extractions respectively on the plurality of first images to obtain the third features of the plurality of first images.

In a possible implementation, clustering the second features of the plurality of first images to obtain a processing result of the plurality of first images includes: clustering the second features of the plurality of first images to determine at least one image group, wherein each of the image groups includes at least one first image; and determining respectively a target class corresponding to the at least one image group, wherein the target class represents an identity of a target in the first images. The processing result includes the at least one image group and the target class corresponding to the at least one image group.

According to one aspect of the present disclosure, there is provided an image processing apparatus, which includes:

A density determining module configured to determine respectively a density of each of first features of a plurality of first images to be processed according to the first features, wherein the density of a first feature represents a number of first features whose distance from said first feature is less than or equal to a first distance threshold; a density chain determining module configured to determine density chain information corresponding to a target feature according to the density of the target feature, wherein the target feature is any one of the first features; the density chain information corresponding to the target feature includes N features; an i^{th} feature of the N features is one of first nearest neighbor features of an (i−1)^{th} feature of the N features, and the density of the i^{th} feature is greater than the density of the (i−1)^{th} feature; N and i are positive integers, and 1<ifeature; N and i are positive integers, and 1-1)e neighbor features of an (i−1)tion corresponding to a t^{th} feature is less than or equal to a second distance threshold, and the target feature is a first one of the N features; a feature adjusting module configured to adjust respectively each of the first features according to the density chain information corresponding to each of the first features, to obtain second features of the plurality of first images; and a result determining module configured to cluster the second features of the plurality of first images to obtain a processing result of the plurality of first images.

In a possible implementation, the density chain information corresponding to the target feature also includes second nearest neighbor features of the N features, and the second nearest neighbor features of the (i−1)^{th} feature of the N features include at least one first feature whose distance from the (i−1)^{th} feature is less than or equal to a third distance threshold; the feature adjusting module includes: a fusion sub-module configured to perform fusion respectively on the N features and the second nearest neighbor features of the N features with regard to the target feature to obtain N fused features of the target feature; a feature sub-module configured to determine an associating feature among the N fused features according to the N fused features of the target feature; and a feature determining sub-module configured to determine the second features of the first image corresponding to the target feature according to the N fused features of the target feature and the associating feature.

In a possible implementation, the feature determining sub-module is configured to splice the associating feature with the N fused features respectively to obtain N spliced features; to normalize the N spliced features to obtain N weight values for the N fused features; and to fuse the N fused features according to the N weight values to obtain the second features of the first images corresponding to the target feature.

In a possible implementation, before the density determining module, the apparatus further includes: a map network establishing module configured to establish a feature map network according to third features of the plurality of first images, wherein the feature map network includes a plurality of nodes and connecting lines among the nodes, with each of the nodes including one of the third features, a value of the connecting line represents a distance between the node and a nearest neighbor node of the node; and the nearest neighbor nodes of the node include K nodes of a minimal distance from the node, where K is a positive integer; and a map convolution module configured to perform a map convolution on the feature map network to obtain the first features of the plurality of first images.

In a possible implementation, the i^{th} feature of the N features is a feature with a maximum density among the first nearest neighbor features of the (i−1)^{th} feature of the N features.

In a possible implementation, in front of the map network establishing module, the apparatus further includes: a feature extracting module configured to perform feature extraction respectively on the plurality of first images to obtain the third features of the plurality of first images.

In a possible implementation, a result determining module includes a clustering sub-module configured to cluster the second features of the plurality of first images and determine at least one image group, wherein each of the image groups includes at least one first image; and a class determining sub-module configured to determine respectively a target class corresponding to the at least one image group, wherein the target class represents an identity of a target in the first images, and the processing result includes the at least one image group and the target class corresponding to the at least one image group.

According to one aspect of the present disclosure, there is provided an electronic device, comprising: a processor; and a memory configured to store processor executable instructions, wherein the processor is configured to invoke the instructions stored in the memory to execute the above method.

According to one aspect of the present disclosure, there is provided a computer readable storage medium storing computer program instructions, wherein the computer program instructions, when executed by a processor, implement the above method.

According to one aspect of the present disclosure, there is provided a computer program including computer readable codes, wherein when the computer readable codes are executed in an electronic device, a processor in the electronic device executes the above method.

According to embodiments of the present disclosure, the density of a plurality of image features can be determined, the density chain information can be determined according to the density of features, the features can be adjusted according to the density chain information, and the adjusted features can be clustered to obtain the processing result; by adjusting the features according to the spatial density distribution of the features, the effect of clustering images can be improved.

It should be understood that the above general descriptions and the following detailed descriptions are only exemplary and illustrative, and do not limit the present disclosure. Other features and aspects of the present disclosure will become apparent from the following detailed descriptions of exemplary embodiments with reference to the accompanying drawings.

### BRIEF DESCRIPTION OF THE DRAWINGS

The drawings described here are incorporated into the specification and constitute a part of the specification. The drawings illustrate embodiments in conformity with the present disclosure and are used to explain the technical solutions of the present disclosure together with the specification.

FIG. 1 illustrates a flow chart of an image processing method according to an embodiment of the present disclosure.

FIG. 2 illustrates a schematic diagram of a density chain determining process in the image processing method according to an embodiment of the present disclosure.

FIG. 3 illustrates a schematic diagram of the density chain information in the image processing method according to an embodiment of the present disclosure.

FIG. 4a, FIG. 4b, FIG. 4c and FIG. 4d illustrate schematic diagrams of an image processing procedure according to embodiments of the present disclosure.

FIG. 5 illustrates a block diagram of an image processing apparatus according to an embodiment of the present disclosure.

FIG. 6 illustrates a block diagram of an electronic device according to an embodiment of the present disclosure.

FIG. 7 illustrates a block diagram of an electronic device according to an embodiment of the present disclosure.

### DETAILED DESCRIPTION

Various exemplary embodiments, features and aspects of the present disclosure are described in detail below with reference to the accompanying drawings. Reference numerals in the drawings refer to elements with same or similar functions. Although various aspects of the embodiments are illustrated in the drawings, the drawings are unnecessary to draw to scale unless otherwise specified.

The term “exemplary” herein means “using as an example and an embodiment or being illustrative”. Any embodiment described herein as “exemplary” should not be construed as being superior or better than other embodiments.

Terms “and/or” used herein is only an association relationship describing the associated objects, which means that there may be three relationships, for example, A and/or B may mean three situations: A exists alone, both A and B exist, and B exists alone. Furthermore, the item “at least one of” herein means any one of a plurality of or any combinations of at least two of a plurality of, for example, “including at least one of A, B and C” may represent including any one or more elements selected from a set consisting of A, B and C.

Furthermore, for better describing the present disclosure, numerous specific details are illustrated in the following detailed description. Those skilled in the art should understand that the present disclosure can be implemented without certain specific details. In some examples, methods, means, elements and circuits that are well known to those skilled in the art are not described in detail in order to highlight the main idea of the present disclosure.

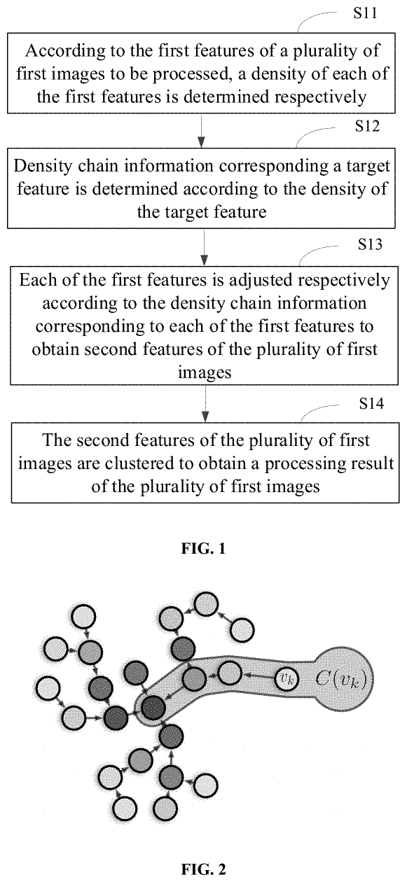

FIG. 1 illustrates a flow chart of an image processing method according to an embodiment of the present disclosure. As shown in FIG. 1, the method includes:

In step S11, according to the first features of a plurality of first images to be processed, a density of each of the first features is determined respectively, wherein the density of a first feature represents the number of first features whose distance from said first feature is less than or equal to a first distance threshold.

In step S12, density chain information corresponding a target feature is determined according to the density of the target feature, wherein the target feature is any one of the first features; the density chain information corresponding to the target feature includes N features; an i^{th} feature of the N features is one of first nearest neighbor features of an (i−1)^{th} feature of the N features, and the density of the i^{th} feature is greater than the density of the (i−1)^{th} feature; N and i are positive integers, and 1<i≤N; and the first nearest neighbor features include at least one first feature whose distance from the (i−1)^{th} feature is less than or equal to a second distance threshold, and the target feature is the first one of the N features.

In step S13, each of the first features is adjusted respectively according to the density chain information corresponding to each of the first features to obtain second features of the plurality of first images.

In step S14, the second features of the plurality of first images are clustered to obtain a processing result of the plurality of first images.

In a possible implementation, the image processing method may be executed by an electronic device such as a terminal device or a server. The terminal device may be a user equipment (UE), a mobile device, a user terminal, a terminal, a cellular phone, a cordless telephone, a personal digital assistant (PDA), a handheld device, a computing device, a vehicle-mounted device, a wearable device, etc. The method may be implemented by a processor invoking computer readable instructions stored in a memory. Or the method may be executed by the server.

In a possible implementation, a plurality of first images to be processed may be images captured by an image capturing device (such as a camera), or partial images intercepted from the captured images, etc. The first image includes a target to be identified (such as a face, a human body, a vehicle, etc.). The targets in the plurality of first images may be targets of a same class (such as the face of a same person), so that the targets of the same class can be clustered together by clustering to facilitate the subsequent processing. The present disclosure does not limit a method of capturing the first images and a specific type of the targets in the first images.

In a possible implementation, the feature information in a plurality of first images may be, for example, extracted by a convolution neural network, and the extracted feature information is used as the first features; and the extracted feature information may also be initially processed, and the processed feature information is used as the first features. The present disclosure does not limit a method of obtaining the first features and the type of the convolution neural network for extracting the features.

In a possible implementation, in step S11, the density of each of the first features may be determined respectively according to the first features of the plurality of first images to be processed. The density of a first feature refers to the number of first features whose distance from said first feature is less than or equal to the first distance threshold. That is, the number of surrounding features within a certain range of each first feature may be determined according to the spatial distribution of the features and used as the density for the location of each first feature. Those skilled in the art may set a specific value of the first distance threshold according to practice, which is not limited in the present disclosure.

In a possible implementation, in step S12, for any one (that may be referred to as the target feature) of the plurality of first features, in accordance with the density of the target feature, one first feature with a large density (greater than the density of the target feature) surrounding the target feature, or a first feature with the maximum density among the first features with densities greater than that of the target feature, may be found, and a marker pointing to that first feature is established. A tree structure may be formed by processing each first feature respectively as described above. A first feature with the maximum density may be found for each first feature along the tree structure, so that a density chain may be found in this way and is referred to as density chain information.

In a possible implementation, the density chain information corresponding to the target feature may be determined for the target feature. Assuming that the density chain information includes N features, then the target feature is the first one of the N features. The first nearest neighbor features of the target feature can be found, including the first features whose distance from the target feature is less than or equal to a second distance threshold. If the density of each of the first nearest neighbor features is less than or equal to the density of the target feature, then N=1, that is, the density chain information corresponding to the target feature includes the target feature itself. If there is a first nearest neighbor feature with a density greater than the density of the target feature, the first nearest neighbor feature is taken as a next feature in the density chain information. The present disclosure does not limit a specific value of the second distance threshold.

In a possible implementation, for the (i−1)^{th} feature of the N features, the first nearest neighbor feature of the (i−1)^{th} feature may be found, including at least one first feature whose distance from the (i−1)^{th} feature is less than or equal to the second distance threshold; and one first nearest neighbor feature with a density greater than the density of the (i−1)^{th} feature is determined as the i feature of the N features, wherein N and i are positive integers, and 1<i≤N. All of the N features may be obtained in the same manner, that is, the density chain information corresponding to the target feature may be obtained.

In a possible implementation, in step S13, in accordance with the density chain information corresponding to each of the first features, each of the first features is adjusted respectively to obtain second features of the plurality of first images. For example, the density chain information may be inputted into a long-short term memory (LSTM) network for processing, and dependencies among various features in the density chain information is learned to obtain a new feature, i.e., the second feature of the first image corresponding to the density chain information, thereby adjusting the corresponding first feature.

In a possible implementation, in step S14, the second features of the plurality of first images may be clustered to obtain a processing result of the plurality of first images. The processing result may include one or more image groups (or image feature groups) obtained by clustering and the target class corresponding to each image group. For example, when the first image is an image of a face, the processing result includes an image group of the face of the same person and the identity of the person. The present disclosure does not limit a specific clustering method.

According to the embodiment of the present disclosure, the density of a plurality of image features can be determined, the density chain information can be determined according to the feature density, the features can be adjusted according to the density chain information, and the adjusted features can be clustered to obtain the processing result. By adjusting the features according to the spatial density distribution of the features, the clustering effect of the images can be improved.

In a possible implementation, prior to the step S11, the method further includes: performing feature extraction respectively on the plurality of first images to obtain third features of the plurality of first images.

For example, for the plurality of first images to be processed, each first image may be inputted into, for example, a convolution neural network for feature extraction, so as to obtain feature information, which may be referred to as the third feature, of each first image. The extracted third features may be taken as the first features; and the extracted third features may be initially processed, and the processed features are taken as the first features. The present disclosure does not limit a specific feature extracting method.

In this way, the feature information of the target in the images may be obtained to facilitate the subsequent processing.

In a possible implementation, following the extraction of the third features, and prior to the step S11, the method further includes:

Establishing a feature map network according to the third features of the plurality of first images, wherein the feature map network includes a plurality of nodes and connecting lines among the nodes; each node includes one of the third features, with a value of the connecting line representing a distance between the node and a nearest neighbor node of that node; and the nearest neighbor nodes of the node include K nodes with a minimal distance from the node, where K is a positive integer. And

Performing a map convolution on the feature map network to obtain the first features of the plurality of first images.

For example, the extracted image features may also be initially processed by the map convolution. The third features of the plurality of first images may be mapped to establish the feature map network. The feature map network includes a plurality of nodes, and each node is a third feature. For each node, K nearest neighbor nodes nearest to the node (i.e. with a minimal distance) may be found. Connecting lines (or referred to as edges) are established between the node and the K nearest neighbor nodes, and each connecting line is assigned with a value. The value of the connecting line may represent the distance (or similarity) between the node and a nearest neighbor node of the node. The established feature map network may be obtained by performing the above process on each node, wherein the feature map network includes a plurality of nodes and the connecting lines among the nodes. Those skilled in the art can determine the nearest neighbor nodes of each node by using various methods in the art. The present disclosure does not limit the method for determining the nearest neighbor nodes and the number K of the nearest neighbor nodes.

In a possible implementation, after the feature map network is established, the map convolution may be used for computation on the feature map network. A feature can be re-computed for each node. The feature is a comprehensive feature with neighbor feature information fused, and can be referred to as the first feature. In this way, the first features of the plurality of first images may be obtained. The present disclosure does not limit a specific computing method of the map convolution.

In this way, the information of the close neighbor features surrounding each feature may be fused so as to realize the fusion of local features, thereby improving the subsequent clustering effect.

In a possible implementation, after the first features of the plurality of first images are obtained, in accordance with the spatial distribution of the features, the density of each first feature, i.e. the number of surrounding features within a certain range of each first feature, may be determined in step S11. In step S12, for any one (referred to as the target feature) of a plurality of first features, the density chain information of the target feature may be acquired. The density chain information includes N features, and the target feature is the first one of the N features.

In a possible implementation, the i^{th} feature of the N features is the feature with the maximum density among the first nearest neighbor features of the (i−1)^{th} feature of the N features. That is, the first nearest neighbor features of the (i−1)^{th} feature may be found, including at least one first feature with a distance from the (i−1)^{th} feature less than or equal to the second distance threshold; and among the first nearest neighbor features, the first nearest neighbor feature which has a density greater than the density of the (i−1)^{th} feature and also has the maximum density is determined as the i^{th} feature of the N features.

FIG. 2 illustrates a schematic diagram of a density chain determining process in the image processing method according to an embodiment of the present disclosure. As shown in FIG. 2, each circle represents a first feature, the darker the color of the circle, the greater the density of the feature is, and the lighter the color of the circle, the smaller the density of the feature is. For any first feature, i.e. the target feature vₖ, the density chain information thereof may be expressed as C(vₖ), including a group of first features starting with the target feature vₖ and ordered by the density from low to high, where k represents a feature number and is a positive integer.

In a possible implementation, the density chain information corresponding to the target feature also includes second nearest neighbor features of the N features. The second nearest neighbor features of the (i−1)^{th} feature of the N features include at least one first feature whose distance from the (i−1)^{th} feature is less than or equal to a third distance threshold. That is, each feature in a density chain is associated with several nearest neighbors (referred to as second nearest neighbor features) of that feature. The N features in the density chain and the second nearest neighbor features of the N features are jointly used as the density chain information. The present disclosure does not limit a specific value of the third distance threshold.

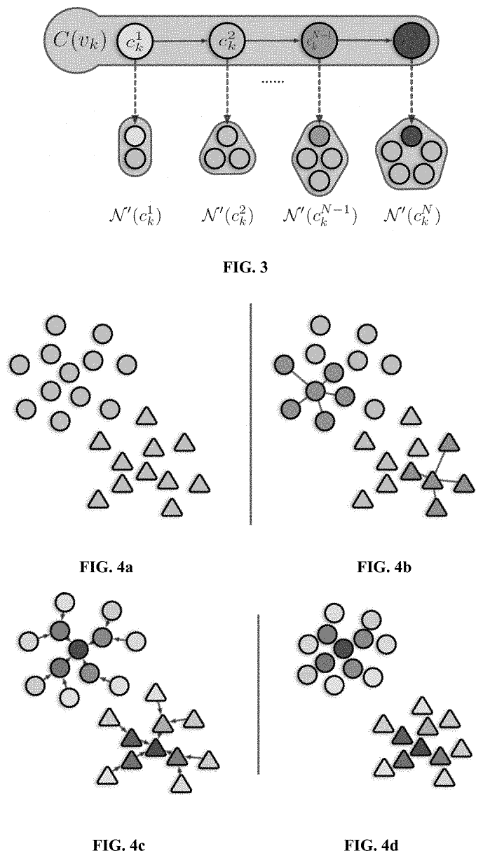

FIG. 3 illustrates a schematic diagram of the density chain information in the image processing method according to the embodiment of the present disclosure. As shown in FIG. 3, for the target feature Vₖ, the density chain information may be expressed as C(vₖ), and the density chain information C(vₖ) includes N features cₖ¹, cₖ², . . . , cₖ^{N-1}, cₖ^{N} and the second nearest neighbor features N′(cₖ¹), N′(cₖ²), . . . , N′(cₖ^{N-1}), N′(cₖ^{N}) of the N features.

In a possible implementation, in step S13, in accordance with the density chain information corresponding to each first features, each first features is adjusted respectively to obtain the second features of the plurality of first images. The step S13 may include:

For the target feature, fusing the N features and the second nearest neighbor features of the N features respectively to obtain N fused features of the target feature.

Determining an associating feature among the N fused features according to the N fused features of the target feature.

Determining the second features of the first images corresponding to the target feature according to the N fused features of the target feature and the associating feature.

For example, for the i^{th} feature in the density chain information of the target feature, the i^{th} feature may be fused with the second nearest neighbor features of the i^{th} feature, that is, a direct concat is performed on the i^{th} feature and the second nearest neighbor features of the i^{th} feature, or a weighted concat is performed on the i^{th} feature and the second nearest neighbor features of the i^{th} feature is performed according to preset weight values, to obtain an i^{th} fused feature. The N fused features may be obtained by processing each of the N features as described above.

In a possible implementation, the N fused features of the target feature may be inputted into a pre-trained LSTM network for processing. Dependencies among the N fused features is learned, and the associating feature (may also be referred to as a query feature “Query”) among the N fused features is outputted. Those skilled in the art can set the LSTM network according to practice. The present disclosure does not limit the network structure of the LSTM network.

In a possible implementation, the step of determining the second features of the first images corresponding to the target feature according to the N fused features of the target feature and the associating feature may include:

Splicing the associating feature respectively with the N fused features to obtain N spliced features.

Normalizing the N spliced features to obtain N weight values for the N fused features.

Fusing the N fused features according to the N weight values to obtain the second features of the first images corresponding to the target feature.

That is, the associating feature may be spliced respectively with the N fused features to obtain the N spliced features (may also be referred to as key features “Key”). The N spliced features may be normalized by, for example, a Softmax function, and the weight value for each fused feature may be obtained, in a total of N weight values. Then the N fused features may be subjected to a weighted average according to the weight values for the respective fused features to obtain a new feature, i.e. the second feature of a first image corresponding to the target feature, thereby an adjusting process of the target feature can be realized. In this way, the second features of the plurality of first images may be obtained by processing each first feature as described above.

In this way, the features may be adjusted according to the spatial density distribution of the features, thereby improving the clustering effect of the images.

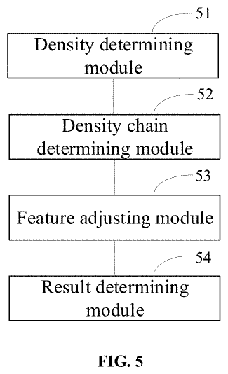

FIG. 4a, FIG. 4b, FIG. 4c and FIG. 4d illustrate schematic diagrams of an image processing procedure according to embodiments of the present disclosure. In an example, after the feature extractions on a plurality of first images, a plurality of third features may be obtained, wherein circles and triangles may respectively represent the features of targets of different classes. FIG. 4a illustrates an initial situation of the feature distribution. As shown in FIG. 4a, the distribution of the third features is relatively scattered, so that the effect of a direct clustering is poor.

In an example, a plurality of third features may be mapped to obtain the feature map network, which includes connecting lines between a plurality of nodes and the nearest neighbor nodes. After the map is established, the map convolution is used for computing, to realize the fusion of local features, and a plurality of first features are obtained. FIG. 4b illustrates a situation of the feature distribution after the processing with the map convolution. As shown in FIG. 4b, after the processing with the map convolution, the distances among nearest neighbor first features are reduced, so that the clustering effect can be improved.

In an example, according to the density of each first feature, directional markers may be established by an order of the density from low to high, to form a tree structure, as shown in FIG. 4c. The density chain information of each first feature then may be determined.

In an example, the density chain information of each first feature may be inputted into the LSTM network, and each first feature is adjusted to obtain a plurality of second features after the adjustment. FIG. 4d illustrates a final situation of the feature distribution. As shown in FIG. 4d, it can be seen that after the adjustment, the distances among the second features of the same class are apparently reduced, so that the clustering is easier, and the clustering effect can be significantly improved.

In a possible implementation, after the adjustment of features (may also be referred to as feature re-learning) is completed, the second features of the plurality of first images may be clustered in step S14 to obtain a processing result of the plurality of first images. The step S14 may include:

Clustering the second features of the plurality of first images to determine at least one image group. Each image group includes at least one first image.

Determining respectively a target class corresponding to the at least one image group. The target class represents the identity of the target in the first image.

The processing result includes the at least one image group and the target class corresponding to the at least one image group.

For example, by clustering, the first images including the targets of the same class may be grouped together. The second features of a plurality of first images may be clustered to determine at least one image group. Each image group includes at least one first image. Those skilled in the art may implement the clustering process by using any clustering method in the related art, which is not limited in the present disclosure.

In a possible implementation, the target class corresponding to the at least one image group may be determined respectively. When the target in the first image is a face or a human body, the target class represents the identity (for example customer A) of the person in the first image. The identity information of the person in each image group may be determined by face identification. In this way, after the clustering and identification, the processing result is finally obtained. The processing result includes at least one image group and the target class corresponding to the at least one image group. In this way, the images of different persons can be distinguished for viewing or for subsequent analysis.

The method according to the embodiments of the present disclosure uses a density-oriented idea to re-learn the features according to the spatial density distribution of the features, and carries out individualized learning and adjustment for the features through the map convolution and the LSTM network, so that both the speed and effect are better than the existing learning algorithms, and the problems of the traditional method that the fine granularity is poor and the overall effect of the algorithm is not good can be solved.

The method according to the embodiments of the present disclosure can be superimposed with the clustering methods in the related art, thereby having a high expandability. That is, if a flow of a clustering method in the related art includes steps of acquiring the features and clustering, the flow after the superimposition includes the steps of acquiring the features, re-learning the features, obtaining new features and clustering. After the superimposition, the effect of the clustering method in the related art can be improved.

The application scenarios of the method according to the embodiments of the present disclosure include, but are not limited to, the clustering of faces of humans, the clustering of general data, and the likes. The method may be applied to the fields of, e.g., intelligent video analysis, security and protection monitoring, and the likes, and can effectively improve the analysis and processing effect on images.

It can be understood that the above method embodiments described in the present disclosure may be combined with each other to form combined embodiments without departing from principles and logics, which are not repeated in the present disclosure due to space limitation. It will be appreciated by those skilled in the art that a specific execution sequence of various steps in the above methods in specific implementations are determined on the basis of their functions and possible intrinsic logics.

Furthermore, the present disclosure further provides an image processing apparatus, an electronic device, a computer-readable storage medium and a program, all of which may be used to implement any image processing method provided by the present disclosure. For the corresponding technical solutions and descriptions, please refer to the corresponding records in the method part, which will not be repeated herein.

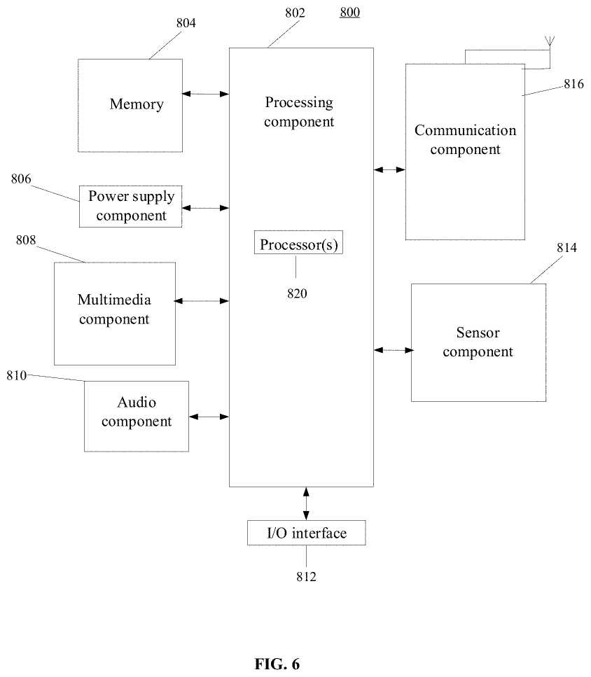

FIG. 5 illustrates a block diagram of an image processing apparatus according to an embodiment of the present disclosure. As shown in FIG. 5, the apparatus includes:

A density determining module 51 configured to respectively determine a density of each first feature according to the first features of the plurality of first images to be processed, wherein the density of a first feature represents the number of first features whose distance from said first feature is less than or equal to a first distance threshold;

A density chain determining module 52 configured to determine density chain information corresponding to a target feature in accordance with the density of the target feature, wherein the target feature is any first feature; the density chain information corresponding to the target feature includes N features; an i^{th} feature of the N features is one of first nearest neighbor features of an (i−1)^{th} feature of the N features, and the density of the i^{th} feature is greater than the density of the (i−1)^{th} feature; N and i are positive integers, and 1<i≤N. The first nearest neighbor features include at least one first feature whose distance from the (i−1)^{th} feature is less than or equal to a second distance threshold, and the target feature is the first one of the N features;

A feature adjusting module 53 configured to adjust respectively each first feature according to the density chain information corresponding to each first feature, to obtain second features of the plurality of first images; and

A result determining module 54 configured to cluster the second features of the plurality of first images to obtain a processing result of the plurality of first images.

In a possible implementation, the density chain information corresponding to the target feature further includes second nearest neighbor features of the N features, and the second nearest neighbor features of the (i−1)^{th} feature of the N features include at least one first feature whose distance from the (i−1)^{th} feature is less than or equal to a third distance threshold. The feature adjusting module includes: a fusion sub-module configured to fuse respectively the N features and the second nearest neighbor features of the N features with regard to the target feature, to obtain N fused features of the target feature; a feature sub-module configured to determine an associating feature among the N fused features according to the N fused features of the target feature; and a feature determining sub-module configured to determine the second features of the first images corresponding to the target feature according to the N fused features of the target feature and the associating feature.

In a possible implementation, the feature determining sub-module is configured to: splice the associating feature respectively with the N fused features to obtain N spliced features; normalize the N spliced features to obtain N weight values for the N fused features; and fuse the N fused features according to the N weight values to obtain the second features of the first images corresponding to the target feature.

In a possible implementation, before the density determining module, the apparatus further includes: a map network establishing module configured to establish a feature map network according to third features of the plurality of first images, wherein the feature map network includes a plurality of nodes and connecting lines among the nodes; each of the nodes includes one of the third features, a value of the connecting line represents a distance between the node and a nearest neighbor node of the node; and the nearest neighbor nodes of the node include K nodes with a minimal distance from the node, where K is a positive integer; and a map convolution module configured to perform a map convolution on the feature map network to obtain the first features of the plurality of first images.

In a possible implementation, the i^{th} feature of the N features is the feature with a maximum density among the first nearest neighbor features of the (i−1)^{th} feature of the N features.

In a possible implementation, before the map network establishing module, the apparatus further includes: a feature extracting module configured to perform feature extractions on the plurality of first images respectively, to obtain third features of the plurality of first images.

In a possible implementation, a result determining module includes a clustering sub-module configured to cluster the second features of the plurality of first images and determine at least one image group, wherein each image group includes at least one first image; and a class determining sub-module configured to respectively determine a target class corresponding to the at least one image group, wherein the target class represents an identity of a target in the first images, and the processing result includes the at least one image group and the target class corresponding to the at least one image group.

In some embodiments, functions or modules of the apparatus provided in the embodiments of the present disclosure may be used to execute the method described in the above method embodiments, which may be specifically implemented by referring to the above descriptions of the method embodiments, and are not repeated herein for brevity.

An embodiment of the present disclosure further provides a computer readable storage medium storing computer program instructions, wherein the computer program instructions, when executed by a processor, implement the above methods. The computer readable storage medium may be a non-volatile computer readable storage medium or a volatile computer readable storage medium.

An embodiment of the present disclosure further provides an electronic device, which includes a processor and a memory configured to store processor executable instructions, wherein the processor is configured to invoke the instructions stored in the memory to execute the above method.

An embodiment of the present disclosure further provides a computer program product, which includes computer readable codes. When the computer readable code is run on the device, the processor in the device executes the instructions for implementing the image processing method as provided in any of the above embodiments.

An embodiment of the present disclosure further provides another computer program product, which is configured to store computer readable instructions. The instructions, when executed, causes the computer to perform operations of the image processing method provided in any of the above embodiments.

The electronic device may be provided as a terminal, a server or a device of any other form.

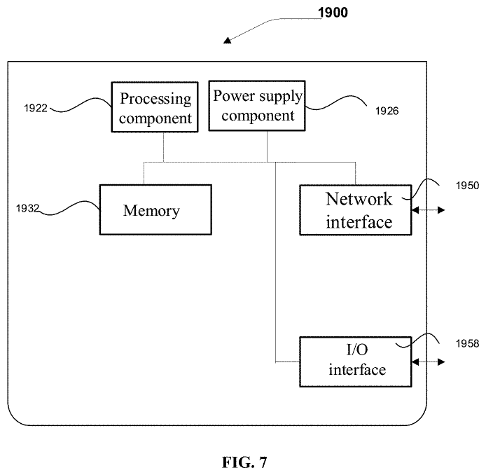

FIG. 6 illustrates a block diagram of an electronic device 800 according to an embodiment of the present disclosure. For example, the electronic device 800 may be a mobile phone, a computer, a digital broadcast terminal, a message transceiver, a game console, a tablet device, medical equipment, fitness equipment, a personal digital assistant or any other terminal.

Referring to FIG. 6, the electronic device 800 may include one or more of the following components: a processing component 802, a memory 804, a power supply component 806, a multimedia component 808, an audio component 810, an input/output (I/O) interface 812, a sensor component 814 and a communication component 816.

The processing component 802 generally controls the overall operation of the electronic device 800, such as operations related to display, phone call, data communication, camera operation and record operation. The processing component 802 may include one or more processors 820 to execute instructions so as to complete all or some steps of the above method. Furthermore, the processing component 802 may include one or more modules for interaction between the processing component 802 and other components. For example, the processing component 802 may include a multimedia module to facilitate the interaction between the multimedia component 808 and the processing component 802.

The memory 804 is configured to store various types of data to support the operations of the electronic device 800. Examples of these data include instructions for any application or method operated on the electronic device 800, contact data, telephone directory data, messages, pictures, videos, etc. The memory 804 may be any type of volatile or non-volatile storage devices or a combination thereof, such as static random access memory (SRAM), electronic erasable programmable read-only memory (EEPROM), erasable programmable read-only memory (EPROM), programmable read-only memory (PROM), read-only memory (ROM), a magnetic memory, a flash memory, a magnetic disk or a compact disk.

The power supply component 806 supplies electric power to various components of the electronic device 800. The power supply component 806 may include a power supply management system, one or more power supplies, and other components related to power generation, management and allocation of the electronic device 800.

The multimedia component 808 includes a screen providing an output interface between the electronic device 800 and a user. In some embodiments, the screen may include a liquid crystal display (LCD) and a touch panel (TP). If the screen includes the touch panel, the screen may be implemented as a touch screen to receive an input signal from the user. The touch panel includes one or more touch sensors to sense the touch, sliding, and gestures on the touch panel. The touch sensor may not only sense a boundary of the touch or sliding action, but also detect the duration and pressure related to the touch or sliding operation. In some embodiments, the multimedia component 808 includes a front camera and/or a rear camera. When the electronic device 800 is in an operating mode such as a shooting mode or a video mode, the front camera and/or the rear camera may receive external multimedia data. Each front camera and rear camera may be a fixed optical lens system or have a focal length and optical zooming capability.

The audio component 810 is configured to output and/or input an audio signal. For example, the audio component 810 includes a microphone (MIC). When the electronic device 800 is in the operating mode such as a call mode, a record mode and a voice identification mode, the microphone is configured to receive the external audio signal. The received audio signal may be further stored in the memory 804 or sent by the communication component 816. In some embodiments, the audio component 810 also includes a loudspeaker which is configured to output the audio signal.

The I/O interface 812 provides an interface between the processing component 802 and a peripheral interface module. The peripheral interface module may be a keyboard, a click wheel, buttons, etc. These buttons may include but are not limited to home buttons, volume buttons, start buttons and lock buttons.

The sensor component 814 includes one or more sensors which are configured to provide state evaluation in various aspects for the electronic device 800. For example, the sensor component 814 may detect an on/off state of the electronic device 800 and relative locations of the components such as a display and a small keyboard of the electronic device 800. The sensor component 814 may also detect the position change of the electronic device 800 or an component of the electronic device 800, presence or absence of a user contact with electronic device 800, directions or acceleration/deceleration of the electronic device 800 and the temperature change of the electronic device 800. The sensor component 814 may include a proximity sensor configured to detect the presence of nearby objects without any physical contact. The sensor component 814 may further include an optical sensor such as a CMOS or CCD image sensor which is used in an imaging application. In some embodiments, the sensor component 814 may further include an acceleration sensor, a gyroscope sensor, a magnetic sensor, a pressure sensor or a temperature sensor.

The communication component 816 is configured to facilitate the communication in a wire or wireless manner between the electronic device 800 and other devices. The electronic device 800 may access a wireless network based on communication standards, such as WiFi, 2G or 3G, or a combination thereof. In an exemplary embodiment, the communication component 816 receives a broadcast signal or broadcast related information from an external broadcast management system via a broadcast channel. In an exemplary embodiment, the communication component 816 further includes a near field communication (NFC) module to promote the short range communication. For example, the NFC module may be implemented on the basis of radio frequency identification (RFID) technology, infrared data association (IrDA) technology, ultra-wide band (UWB) technology, Bluetooth (BT) technology and other technologies.

In exemplary embodiments, the electronic device 800 may be implemented by one or more application dedicated integrated circuits (ASIC), digital signal processors (DSP), digital signal processing device (DSPD), programmable logic device (PLD), field programmable gate array (FPGA), controllers, microcontrollers, microprocessors or other electronic elements and is used to execute the above method.

In an exemplary embodiment, there is further provided a non-volatile computer readable storage medium, such as a memory 804 including computer program instructions. The computer program instructions may be executed by a processor 820 of an electronic device 800 to implement the above method.

FIG. 7 illustrates a block diagram of an electronic device 1900 according to an embodiment of the present disclosure. For example, the electronic device 1900 may be provided as a server. Referring to FIG. 7, the electronic device 1900 includes a processing component 1922, and further includes one or more processors and memory resources represented by a memory 1932 and configured to store instructions executed by the processing component 1922, such as an application program. The application program stored in the memory 1932 may include one or more modules each corresponding to a group of instructions. Furthermore, the processing component 1922 is configured to execute the instructions so as to execute the above method.

The electronic device 1900 may further include a power supply component 1926 configured to perform power supply management on the electronic device 1900, a wire or wireless network interface 1950 configured to connect the electronic device 1900 to a network, and an input/output (I/O) interface 1958. The electronic device 1900 may run an operating system stored in the memory 1932, such as Windows Server™, Mac OS X™, Unix™, Linux™, FreeBSD™ or the like.

In an exemplary embodiment, there is further provided a non-volatile computer readable storage medium, such as a memory 1932 including computer program instructions. The computer program instructions may be executed by a processing module 1922 of an electronic device 1900 to execute the above method.

The present disclosure may be implemented by a system, a method, and/or a computer program product. The computer program product may include a computer readable storage medium having computer readable program instructions for causing a processor to carry out the aspects of the present disclosure stored thereon.

The computer readable storage medium can be a tangible device that can retain and store instructions used by an instruction executing device. The computer readable storage medium may be, but not limited to, e.g., electronic storage device, magnetic storage device, optical storage device, electromagnetic storage device, semiconductor storage device, or any proper combination thereof. A non-exhaustive list of more specific examples of the computer readable storage medium includes: portable computer diskette, hard disk, random access memory (RAM), read-only memory (ROM), erasable programmable read-only memory (EPROM or Flash memory), static random access memory (SRAM), portable compact disc read-only memory (CD-ROM), digital versatile disk (DVD), memory stick, floppy disk, mechanically encoded device (for example, punch-cards or raised structures in a groove having instructions recorded thereon), and any proper combination thereof. A computer readable storage medium referred herein should not to be construed as transitory signal per se, such as radio waves or other freely propagating electromagnetic waves, electromagnetic waves propagating through a waveguide or other transmission media (e.g., light pulses passing through a fiber-optic cable), or electrical signal transmitted through a wire.

Computer readable program instructions described herein can be downloaded to individual computing/processing devices from a computer readable storage medium or to an external computer or external storage device via network, for example, the Internet, local area network, wide area network and/or wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium in the respective computing/processing devices.

Computer readable program instructions for carrying out the operations of the present disclosure may be assembler instructions, instruction-set-architecture (ISA) instructions, machine instructions, machine-related instructions, microcode, firmware instructions, state-setting data, or source code or object code written in any combination of one or more programming languages, including an object oriented programming language, such as Smalltalk, C++ or the like, and the conventional procedural programming languages, such as the “C” programming language or similar programming languages. The computer readable program instructions may be executed completely on the user's computer, partly on the user's computer, as a stand-alone software package, partly on the user's computer and partly on a remote computer, or completely on a remote computer or a server. In the scenario with remote computer, the remote computer may be connected to the user's computer through any type of network, including local area network (LAN) or wide area network (WAN), or connected to an external computer (for example, through the Internet connection from an Internet Service Provider). In some embodiments, electronic circuitry, such as programmable logic circuitry, field-programmable gate arrays (FPGA), or programmable logic arrays (PLA), may be customized from state information of the computer readable program instructions; and the electronic circuitry may execute the computer readable program instructions, so as to achieve the aspects of the present disclosure.

Aspects of the present disclosure have been described herein with reference to the flowchart and/or the block diagrams of the method, device (systems), and computer program product according to the embodiments of the present disclosure. It will be appreciated that each block in the flowchart and/or the block diagram, and combinations of blocks in the flowchart and/or block diagram, can be implemented by the computer readable program instructions.

These computer readable program instructions may be provided to a processor of a general purpose computer, a dedicated computer, or other programmable data processing devices, to produce a machine, such that the instructions create means for implementing the functions/acts specified in one or more blocks in the flowchart and/or block diagram when executed by the processor of the computer or other programmable data processing devices. These computer readable program instructions may also be stored in a computer readable storage medium, wherein the instructions cause a computer, a programmable data processing device and/or other devices to function in a particular manner, such that the computer readable storage medium having instructions stored therein includes a product that includes instructions implementing aspects of the functions/acts specified in one or more blocks in the flowchart and/or block diagram.

The computer readable program instructions may also be loaded onto a computer, other programmable data processing devices, or other devices to have a series of operational steps performed on the computer, other programmable devices or other devices, so as to produce a computer implemented process, such that the instructions executed on the computer, other programmable devices or other devices implement the functions/acts specified in one or more blocks in the flowchart and/or block diagram.

The flowcharts and block diagrams in the drawings illustrate the architecture, function, and operation that may be implemented by the system, method and computer program product according to the various embodiments of the present disclosure. In this regard, each block in the flowchart or block diagram may represent a part of a module, a program segment, or a portion of code, which includes one or more executable instructions for implementing the specified logical function(s). In some alternative implementations, the functions denoted in the blocks may occur in an order different from that denoted in the drawings. For example, two contiguous blocks may, in fact, be executed substantially concurrently, or sometimes they may be executed in a reverse order, depending upon the functions involved. It will also be noted that each block in the block diagram and/or flowchart, and combinations of blocks in the block diagram and/or flowchart, can be implemented by dedicated hardware-based systems performing the specified functions or acts, or by combinations of dedicated hardware and computer instructions.

The computer program product may be implemented specifically by hardware, software or a combination thereof. In an optional embodiment, the computer program product is specifically embodied as a computer storage medium. In another optional embodiment, the computer program product is specifically embodied as a software product, such as software development kit (SDK) and the like.

Without violating logic, different embodiments of the present disclosure can be combined with each other, and the descriptions of different embodiments are emphasized. The emphasized part of the description can be found in descriptions of other embodiments.

Although the embodiments of the present disclosure have been described above, it will be appreciated that the above descriptions are merely exemplary, but not exhaustive; and that the disclosed embodiments are not limiting. A number of variations and modifications may occur to one skilled in the art without departing from the scopes and spirits of the described embodiments. The terms in the present disclosure are selected to provide the best explanation on the principles and practical applications of the embodiments and the technical improvements to the arts on market, or to make the embodiments described herein understandable to one skilled in the art.

1. An imaging processing method, comprising:
according to first features of a plurality of first images to be processed, determining respectively a density of each of the first features, wherein the density of a first feature represents a number of first features whose distance from said first feature is less than or equal to a first distance threshold;
determining density chain information corresponding to a target feature according to the density of the target feature, wherein the target feature is any one of the first features; the density chain information corresponding to the target feature includes N features; an i^{th} feature of the N features is one of first nearest neighbor features of an (i−1)^{th} feature of the N features, and the density of the i^{th} feature is greater than the density of the (i−1)^{th} feature; N and i are positive integers, and 1<i≤N; the first nearest neighbor features include at least one first feature whose distance from the (i−1)^{th} feature is less than or equal to a second distance threshold, and the target feature is a first one of the N features;
adjusting respectively each of the first features according to the density chain information corresponding to each of the first features, to obtain second features of the plurality of first images; and
clustering the second features of the plurality of first images to obtain a processing result of the plurality of first images.

2. The method according to claim 1, wherein the density chain information corresponding to the target feature further includes second nearest neighbor features of the N features, and the second nearest neighbor features of the (i−1)^{th} feature of the N features include at least one first feature whose distance from the (i−1)^{th} is feature less than or equal to a third distance threshold, and
adjusting respectively each of the first features according to the density chain information corresponding to each of the first features to obtain second features of the plurality of first images comprises:
for the target feature, fusing respectively the N features and the second nearest neighbor features of the N features to obtain N fused features of the target feature;
determining an associating feature among the N fused features according to the N fused features of the target feature; and
determining the second features of the first images corresponding to the target feature according to the N fused features of the target feature and the associating feature.

3. The method according to claim 2, wherein determining the second features of the first images corresponding to the target feature according to the N fused features of the target feature and the associating feature comprises:
splicing the associating feature respectively with the N fused features to obtain N spliced features;
normalizing the N spliced features to obtain N weight values for the N fused features; and
fusing the N fused features according to the N weight values to obtain the second features of the first images corresponding to the target feature.

4. The method according to claim 1, wherein prior to determining respectively a density of each of the first features according to first features of a plurality of first images to be processed, the method further includes:
establishing a feature map network according to third features of the plurality of first images, wherein the feature map network includes a plurality of nodes and connecting lines among the nodes; each of the nodes includes one of the third features, and a value of the connecting line represents a distance between the node and a nearest neighbor node of the node; and the nearest neighbor nodes of the node include K nodes of a minimal distance from the node, where K is a positive integer; and
performing a map convolution on the feature map network to obtain the first features of the plurality of first images.

5. The method according to claim 1, wherein the i^{th} feature of the N features is a feature with a maximum density among the first nearest neighbor features of the (i−1)^{th} feature of the N features.

6. The method according to claim 4, wherein prior to establishing a feature map network according to third features of the plurality of first images, the method further comprises:
performing feature extractions respectively on the plurality of first images to obtain the third features of the plurality of first images.

7. The method according to claim 1, wherein clustering the second features of the plurality of first images to obtain a processing result of the plurality of first images comprises:
clustering the second features of the plurality of first images to determine at least one image group, wherein each of the image groups includes at least one first image; and
determining respectively a target class corresponding to the at least one image group, wherein the target class represents an identity of a target in the first images,
wherein the processing result includes the at least one image group and the target class corresponding to the at least one image group.

8. An imaging processing apparatus, comprising:
a processor; and
a memory storing processor executable instructions;
wherein the processor is configured to invoke the processor executable instructions stored in the memory to:
according to first features of a plurality of first images to be processed, determine respectively a density of each of the first features, wherein the density of a first feature represents a number of first features whose distance from said first feature is less than or equal to a first distance threshold;
determine density chain information corresponding to a target feature according to the density of the target feature, wherein the target feature is any one of the first features; the density chain information corresponding to the target feature includes N features; an i^{th} feature of the N features is one of first nearest neighbor features of an (i−1)^{th} feature of the N features, and the density of the i^{th} feature is greater than the density of the (i−1)^{th} feature; N and i are positive integers, and 1<i≤N; the first nearest neighbor features include at least one first feature whose distance from the (i−1)^{th} feature is less than or equal to a second distance threshold, and the target feature is a first one of the N features;
adjust respectively each of the first features according to the density chain information corresponding to each of the first features, to obtain second features of the plurality of first images; and
cluster the second features of the plurality of first images to obtain a processing result of the plurality of first images.

9. The apparatus according to claim 8, wherein the density chain information corresponding to the target feature further includes second nearest neighbor features of the N features, and the second nearest neighbor features of the (i−1)^{th} feature of the N features include at least one first feature whose distance from the (i−1)^{th} is feature less than or equal to a third distance threshold, and
adjusting respectively each of the first features according to the density chain information corresponding to each of the first features to obtain second features of the plurality of first images comprises:
for the target feature, fusing respectively the N features and the second nearest neighbor features of the N features to obtain N fused features of the target feature;
determining an associating feature among the N fused features according to the N fused features of the target feature; and
determining the second features of the first images corresponding to the target feature according to the N fused features of the target feature and the associating feature.

10. The apparatus according to claim 9, wherein determining the second features of the first images corresponding to the target feature according to the N fused features of the target feature and the associating feature comprises:
splicing the associating feature respectively with the N fused features to obtain N spliced features;
normalizing the N spliced features to obtain N weight values for the N fused features; and
fusing the N fused features according to the N weight values to obtain the second features of the first images corresponding to the target feature.

11. The apparatus according to claim 8, wherein prior to determining respectively a density of each of the first features according to first features of a plurality of first images to be processed, the processor is further configured to:
establish a feature map network according to third features of the plurality of first images, wherein the feature map network includes a plurality of nodes and connecting lines among the nodes; each of the nodes includes one of the third features, and a value of the connecting line represents a distance between the node and a nearest neighbor node of the node; and the nearest neighbor nodes of the node include K nodes of a minimal distance from the node, where K is a positive integer; and
perform a map convolution on the feature map network to obtain the first features of the plurality of first images.

12. The apparatus according to claim 8, wherein the i^{th} feature of the N features is a feature with a maximum density among the first nearest neighbor features of the (i−1)^{th} feature of the N features.

13. The apparatus according to claim 11, wherein prior to establishing a feature map network according to third features of the plurality of first images, the processor is further configured to:
perform feature extractions respectively on the plurality of first images to obtain the third features of the plurality of first images.

14. The apparatus according to claim 8, wherein clustering the second features of the plurality of first images to obtain a processing result of the plurality of first images comprises:
clustering the second features of the plurality of first images to determine at least one image group, wherein each of the image groups includes at least one first image; and
determining respectively a target class corresponding to the at least one image group, wherein the target class represents an identity of a target in the first images,
wherein the processing result includes the at least one image group and the target class corresponding to the at least one image group.

15. A non-transient computer readable storage medium storing computer program instructions, wherein the computer program instructions, when executed by a processor, cause the processor to:
according to first features of a plurality of first images to be processed, determine respectively a density of each of the first features, wherein the density of a first feature represents a number of first features whose distance from said first feature is less than or equal to a first distance threshold;
determine density chain information corresponding to a target feature according to the density of the target feature, wherein the target feature is any one of the first features; the density chain information corresponding to the target feature includes N features; an i^{th} feature of the N features is one of first nearest neighbor features of an (i−1)^{th} feature of the N features, and the density of the i^{th} feature is greater than the density of the (i−1)^{th} feature; N and i are positive integers, and 1<i≤N; the first nearest neighbor features include at least one first feature whose distance from the (i−1)^{th} feature is less than or equal to a second distance threshold, and the target feature is a first one of the N features;
adjust respectively each of the first features according to the density chain information corresponding to each of the first features, to obtain second features of the plurality of first images; and
cluster the second features of the plurality of first images to obtain a processing result of the plurality of first images.

16. The non-transient computer readable storage medium according to claim 15, wherein the density chain information corresponding to the target feature further includes second nearest neighbor features of the N features, and the second nearest neighbor features of the (i−1)^{th} feature of the N features include at least one first feature whose distance from the (i−1)^{th} is feature less than or equal to a third distance threshold, and
adjusting respectively each of the first features according to the density chain information corresponding to each of the first features to obtain second features of the plurality of first images comprises:
for the target feature, fusing respectively the N features and the second nearest neighbor features of the N features to obtain N fused features of the target feature;
determining an associating feature among the N fused features according to the N fused features of the target feature; and
determining the second features of the first images corresponding to the target feature according to the N fused features of the target feature and the associating feature.

17. The non-transient computer readable storage medium according to claim 16, wherein determining the second features of the first images corresponding to the target feature according to the N fused features of the target feature and the associating feature comprises:
splicing the associating feature respectively with the N fused features to obtain N spliced features;
normalizing the N spliced features to obtain N weight values for the N fused features; and
fusing the N fused features according to the N weight values to obtain the second features of the first images corresponding to the target feature.

18. The non-transient computer readable storage medium according to claim 15, wherein prior to determining respectively a density of each of the first features according to first features of a plurality of first images to be processed, the computer program instructions further cause the processor to:
establish a feature map network according to third features of the plurality of first images, wherein the feature map network includes a plurality of nodes and connecting lines among the nodes; each of the nodes includes one of the third features, and a value of the connecting line represents a distance between the node and a nearest neighbor node of the node; and the nearest neighbor nodes of the node include K nodes of a minimal distance from the node, where K is a positive integer; and
perform a map convolution on the feature map network to obtain the first features of the plurality of first images.

19. The non-transient computer readable storage medium according to claim 15, wherein the i^{th} feature of the N features is a feature with a maximum density among the first nearest neighbor features of the (i−1)^{th} feature of the N features.

20. The non-transient computer readable storage medium according to claim 18, wherein prior to establishing a feature map network according to third features of the plurality of first images, the computer program instructions further cause the processor to:
perform feature extractions respectively on the plurality of first images to obtain the third features of the plurality of first images.
